(19) United States
(12) Patent Application Publication
(10) Pub. No.: US 2016/0039123 A1
(43) Pub. Date: Feb. 11, 2016

(54) METHOD FOR MANUFACTURING AN OBJECT HAVING A COMPLEX SHAPE FROM A CURED ORGANIC OR INORGANIC MATERIAL

(71) Applicant: COMMISSARIAT À L'ÉNERGIE ATOMIQUE ET AUX ÉNERGIES ALTERNATIVES, Paris (FR)

(72) Inventors: Veronique MOURIER, Saint Jean de Moirans (FR); Pascal REVIRAND, Saint Egreve (FR); Gaelle MAUGUEN, Grenoble (FR); Tarek FATHALLAH, Voiron (FR)

(73) Assignee: Commissariat a l'energie atomique et aux energies alternatives, Paris (FR)

(21) Appl. No.: 14/780,759

(22) PCT Filed: Mar. 25, 2014
(86) PCT No.: PCT/EP2014/055991

§ 371 Date: Sep. 28, 2015

(30) Foreign Application Priority Data
Mar. 28, 2013 (FR) 1352838

(51) Int. Cl. B29C 37/00; B29C 45/16; B29C 45/00; B29C 33/38; B29C 33/40; B29C 45/26; B29C 35/02; B29C 45/37

(52) U.S. Cl. CPC B29C 37/006; B29C 35/02; B29C 45/1671; B29C 45/37; B29C 45/16; B29C 33/3814; B29C 33/405; B29C 45/2608; B29C 45/0001; B29K 2083/00

(57) ABSTRACT

The invention relates to a method for manufacturing a molded object from a mold comprising an internal cavity comprising one or several compartments and at least one removable part present within said internal cavity, said object being in a cured organic or inorganic material, said method successively comprising at least one cycle of following steps:
a) a step for completely filling at least one compartment of the internal cavity of the mold, said compartment having a shape corresponding to all or part of the object, which one wishes to obtain, with a liquid composition which is curable by chemical reaction in order to form said material, said composition comprising at least one solvent;
b) a step for curing by chemical reaction said composition within said mold;
c) a step for withdrawing at least one removable part of said mold; and
d) a step for drying within said mold the cured composition obtained in b),
wherein all or part of steps a) to d) may be repeated with a curable liquid composition either identical or different from the one used during said cycle until the molded object is obtained and,
wherein said mold, at least during the application of each step d) is a closed chamber, the walls of which forming a boundary between the internal cavity and the outside of the mold are in at least one material able to allow discharge of the gases from said step d).

### TECHNICAL FIELD

The present invention relates to a method for manufacturing a molded article of a cured inorganic or organic material, of complex shape, said method taking place in a medium comprising at least one solvent, especially an organic solvent, water or a mixture comprising water and an organic solvent, said inorganic cured material conventionally being a material derived from a sol-gel method, whereas the cured organic material is conventionally a polymeric organic material.

This method because of the variety of objects which it may prepare, finds application in many fields, which will be discussed hereafter.

### STATE OF THE PRIOR ART

The preparation of an object in an organic polymeric material may mostly occur in two processes, which are the following:
chain polymerization; and
stepwise polymerization, such as polycondensation.

Within the scope of chain polymerization, this implies at least one step for polymerizing material precursors, these precursors may be monomers or even oligomers which react together after having formed active centers (such as radicals or ions) in order to form polymeric chains making up said material.

Within the scope of stepwise polymerization, this implies at least one step for polymerizing material precursors by reaction between functional groups borne by these precursors, one of the standard examples of stepwise polymerization being polycondensation.

Alternatively, the preparation of an object in a polymeric material may instead of a polymerization step stricto sensu, involve a step for cross-linking pre-existing polymeric chains, which means in other words that these polymeric chains will form at the end of the cross-linking step, a three-dimensional network consisting of polymeric chains bound to each other via cross-linking bridges. In other words, the pre-existing polymeric chains include functions capable of reacting with a cross-linking agent during the cross-linking reaction, in order to form said three-dimensional network (this is referred to as chemical cross-linking) or further include functions capable of spontaneously reacting with each other or subsequently to a physical stimulation (this is referred to as physical cross-linking).

Whether this is for the polymerization step or the cross-linking step, when they are carried out in a medium comprising a solvent, the object resulting from these steps is an object which may confine, inside it, at least one portion of the solvent which should be removed for completing the making of the object.

Drying techniques, such as drying with evaporation, generates a dry object (i.e. without any solvent), which may have disadvantageously small cracks and cracking flaws, due to the presence of strong surface stresses at the pores confining the solvent. Furthermore, when this technique is applied with a polymerizable solution cast into an outwardly open mold (when the intention is notably to make an object which is more complex than a monolith), it is found that the drying of the object is not homogeneous along all directions, which may lead to an object, for which the shape does not correspond to the initial mold. Finally, non-homogeneous drying of the object moreover induces additional mechanical stresses, which promotes the occurrence of cracks within the object.

As to the preparation of an object via a sol-gel route, this consists of preparing a solution containing precursors on the basis of metal or metalloid elements (which may be organometallic compounds or metal salts) and one or several organic solvents, the resulting solution thereby forming a sol (which may also be called a sol-gel solution). Because of the addition of water to the formulation, the precursors contained in this sol-gel solution are partly subject to a hydrolysis step and to a condensation step, in order to form an oxide network confining the solvent, so as to form a gel. The gel is then caused to be dried, in order to form at the end of this drying, a monolithic object.

At the present time, two drying techniques prevail:
evaporative drying; and
supercritical drying.

Evaporative drying consists of removing the organic solvent(s) present in the sol-gel solution by heating at atmospheric pressure or under reduced pressure (i.e., a pressure below atmospheric pressure). At the end of this drying, a dry gel (also called xerogel) is obtained appearing as a porous monolith which may disadvantageously have small cracks and cracking flaws due to the presence of strong surface stresses at the pores. Furthermore, when this technique is applied with a sol-gel solution cast into an outwardly open mold (when the intention is to notably produce an object with a more complex shape than a monolith), it is found that the drying of the gel is not homogenous along all directions, which may lead to an object, the shape of which does not correspond to the initial mold. Finally, the non-homogeneous drying of the gel moreover induces additional mechanical stresses, which promote the occurrence of cracks within the object.

As to supercritical drying, it consists, as indicated by its name, of submitting the sol-gel solution to supercritical conditions, in return for which the gas phase and the liquid phase become indiscernible. This drying principle is notably used in the method described in U.S. Pat. No. 7,216,509.

If this drying technique gives the possibility of obtaining drying of the object in its mold without any volume shrinkage, the use of an outwardly open mold however does not give the possibility of obtaining control on all the faces of the obtained object, notably on the face which is directly in contact with the outside.

Thus, as a summary, whether this is for the polymerization, the cross-linking or the sol-gel route, when they are achieved in a medium comprising a solvent, the drying of the object is conventionally not homogenous along all directions, which may lead to an object, the shape of which does not correspond to the initial mold, which prevents the making of objects with a complex shape. Finally, the non-homogenous drying of the object moreover induces additional mechanical stresses which promote the occurrence of cracks within the object.

Considering what exists, the authors of the present invention therefore set the goal of proposing a method for making a specific molded object in a cured inorganic or organic material not having the aforementioned drawbacks and which furthermore give the possibility of obtaining objects with a complex shape.

### DISCUSSION OF THE INVENTION

In order to overcome these drawbacks, the authors of the present invention propose a method for making a molded object from a mold comprising an internal cavity comprising one or several compartments and at least one removable part present within said internal cavity, said object being in a cured organic or inorganic material, said method successively comprising at least one cycle of the following steps:

a) a step for completely filling at least one compartment of the internal cavity of the mold, said compartment having a shape corresponding to all or part of the object, which one wishes to obtain, with a liquid composition which may be cured by chemical reaction in order to form said material, said composition comprising at least one solvent;

b) a curing step by chemical reaction of said composition within said mold;

c) a step for removing at least one removable part from said mold; and

d) a step for drying within said mold the cured composition obtained in b),

wherein all or part of the steps a) to d) may be repeated with a curable liquid composition identical with or different from the one used during said cycle until the molded object is obtained and,

wherein said mold, at least during the application of each step d), is a closed chamber, the walls of which forming a boundary between the internal cavity and the outside of the mold, are in at least one material able to allow discharge of the gases from said step d).

Before entering into more details in the discussion of the invention, we specify the following definitions.

By [symbol] mold consisting in a closed chamber [symbol] , is meant a mold, the internal cavity of which is not in direct communication with the outside of said mold (or, in other words, with the ambient atmosphere of said mold) at least during the application of step d), which means, in other words that the internal cavity is isolated from the ambient atmosphere surrounding said mold at least during the application of step d). Furthermore, the walls forming a boundary between the internal cavity and the outside of the mold are in a material capable of discharging the gases from step d) and optionally from step b) (these gases totally or partly originate from the evaporation of the solvent(s)), which allows homogenous discharge of said gases at all the external faces of the object. The result of this is homogenous control of the dimensions of the object.

The mold comprises, within the internal cavity, one or several compartments, which gives the possibility of making objects of a complex shape. When there are several distinct compartments, the latter may be generated by the presence of one or several removable parts, for example appearing as integrated cylinders or beams for producing parts which may have holes corresponding to the shape of the added elements. The removable part(s) is(are) intended to be withdrawn during step c), which may imply within the mold the presence of a system for withdrawing these parts without opening the mold.

The mold may further comprise at least one inlet orifice allowing communication between the outside and the internal cavity, with view to applying step a), it being understood that this orifice will be obturated with view to applying at least step d), preferably with a material able to allow discharge of the gases from step d) and optionally from step b).

As mentioned above, the mold is a specific mold with a closed chamber as defined above, at least for applying step d). It may be defined in the same way for applying step b) or even for applying step a), in which case the step a) may be applied, as this will be explained below, by introducing a syringe comprising the curable composition into the internal cavity of the mold by simply crossing the wall. A mold adapted to this scenario is a mold consisting in a closed chamber formed in a single block (also said to be a one-piece block), the walls of which delimiting the internal cavity from the outside exclusively consist of a block of said material able to discharge the gases formed during step d) and optionally during step b). It is understood that the material able to discharge the gas formed during step d) and optionally during step b) is an integral part of the mold and thus does not result from a provided element, such as a lid added subsequently.

By the use of a mold with a closed chamber, the walls of which delimiting the internal cavity from the outside of the mold are in a material able to discharge the gases from step d) and optionally from step b), the method of the invention fills the loopholes encountered in the methods of the prior art and notably gives the possibility of obtaining:
objects which may have a complex geometry on all the faces;
a control of drying giving the possibility of standardizing the latter, which is expressed by uniform retraction of the cured object and thus observation of the relative sides of the object, which one wishes to obtain, as compared with the mold of this object and which is also expressed by better control of the microstructural characteristics of the object; in other words, the method gives the possibility of retaining the proportionality between the dimensions of the object, when the object contracts under the effect of drying;
a confinement of the atmosphere existing in the mold, which gives the possibility of preserving the object from the outside and of thereby preventing possible cracks, and also performing drying at a pressure below atmospheric pressure and therefore reducing the duration of this drying.

Preferably, the thickness of the walls of the mold is identical on the entirety of the mold, which gives the possibility of ensuring a uniform drying rate in all points of the mold.

As mentioned above, because of the presence of one or several removable parts within the internal cavity of the mold and because of the possibility of being able to proceed with several distinct injection steps, it is possible to obtain objects of complex shape and notably having distinct portions from each other. These distinct portions may be chemically and/or physically (or mechanically) associated and may have distinct properties, notably in terms of optical index, thermal conductivity, electrical conductivity, thermal expansion, coloration, or more extensively in terms of dielectric properties, mechanical properties, physical properties, chemical properties. It is specified that by [symbol] chemically associated portions [symbol] are meant portions bound through strong chemical bonds formed during a curing step b). Moreover it is specified that by [symbol] physically associated portions [symbol] or [symbol] mechanically associated portions [symbol] are meant portions bound through their three-dimensional conformations. It is understood that a same object may include both chemically associated portions and physically associated portions. It is also understood that the object may include portions in a material other than a cured organic or inorganic material obtained by the method, such as inserts or further quite simply vacant spaces for example resulting from the withdrawal of the removable part(s) present in the internal cavity of the mold.

As mentioned above, the method of the invention comprises a step for completely filling at least one compartment of the internal cavity of the mold with a curable liquid composition intended to form the material making up the aforementioned object.

This filling step is conventionally achieved by injecting said composition into at least one compartment of the internal cavity of the mold until the latter is filled up completely, for example, via a syringe crossing the wall of the mold (notably when the mold is based on an elastomeric material), this filling step may be achieved in several times (either successively or in a non-successive way), notably when the internal cavity of the mold is divided into several compartments.

During application of step a), the mold may thus be a mold with a closed chamber, because the walls of the mold are in an elastomeric material, which allows the introduction of a syringe into the internal cavity without opening the mold, the elastomeric material retracting upon removal of the syringe, which gives the possibility of maintaining the mold with a closed chamber for at least the application of step d).

The walls of the mold delimiting the outside of the mold from the internal cavity are in a material able to allow discharge of the gases produced during step d) and optionally step b), these gases in particular being those resulting from the evaporation of the solvent during the aforementioned drying step. They may also result from other products of the reaction mixture, such as water, secondary products from the curing step.

A material meeting these specificities may be an elastomeric material, for example, an elastomeric material from the family of polysiloxanes.

More particularly, such a material may be an elastomeric material belonging to the family of polydimethylsiloxanes, this family being characterized by the presence of a chain of recurrent units of the following formula (I):

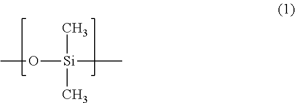

In addition to the capability of allowing discharges of the gases from step d) and optionally b), the elastomeric materials have the advantage of absorbing the mechanical stresses generated during the curing step and the drying step. On the other hand, these elastomeric materials have excellent molding properties, which allow them to perfectly observe the dimensions of the initial object.

Certain elastomeric materials, as this is the case of polydimethylsiloxanes, are transparent to UV rays, which make them interesting when the intention is to induce by UV rays, polymerization or cross-linking of the composition introduced into the mold during step a).

The mold may be based on organic materials other than those mentioned above or on other inorganic materials, from the moment that they are capable of allowing discharge of the gases produced during at least the drying step.

Before step a), the method of the invention may comprise a step for preparing the mold of the object to be made.

This preparation step may consist of molding a part with a shape totally or partly corresponding to that of the object, which one wishes to make, in return for which from this step, a mold results, having an internal cavity for which the walls delimiting the outside of the mold from the internal cavity of the latter are in a material capable of allowing discharge of the gases formed during step d) and optionally during step b).

Depending on the nature of the material making up the mold, this preparation step may take place according to different alternatives.

As an example, when the mold comprises a material of the polydimethylsiloxane type, the step for preparing the mold may comprise the following operations:
an operation for putting a part with a shape corresponding to all or part of the object which one wishes to make, into contact with a solution comprising:
a polymer comprising, in its main chain, a sequence of a recurrent unit of formula (I) as defined above and at least two ethylene terminal groups; and
a cross-linking agent;
an operation for cross-linking said solution; and
an operation for withdrawing the initial part, in return for which said mold subsists comprising an internal cavity, the shape of which corresponds to the imprint of the original part.

The contacting operation may be carried out in a container in which the aforementioned part is placed, this container being filled with a solution as defined above.

The aforementioned polymer may correspond to a polymer of the following formula (II):

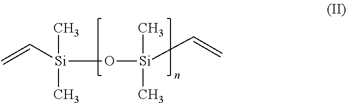

wherein n represents the number of repetitions of the recurrent unit taken between brackets.

The cross-linking agent may be of various types.

When a hot cross-linking operation has to be carried out, the cross-linking agent may be one or several organic peroxides, such as benzoyl peroxide, dicumyl peroxide and mixtures thereof.

When a cold cross-linking operation has to be carried out, which is notably the case with two-component elastomers, the cross-linking agent may be:
a tetra-functional alkyl silicate in the presence of an organotin catalyst and of a platinum salt;
a cross-linking agent of the R—SiX₃ or SiX₄ type in the presence of a metal salt, wherein R may be an alkyl group and X may be a hydrolyzable group, such as an acetoxy, alkoxy, amino, amido group.

The aforementioned solution may be commercially available, for example as a kit comprising two portions, a first portion comprising said polymer and a second portion comprising said cross-linking agent, both of these portions have to be mixed in order to form the solution.

The cross-linking operation may consist, when cross-linking has to be carried out under hot conditions, of heating the assembly formed by the part and the solution to a suitable temperature and for a suitable duration (this is then referred to as thermo-crosslinking) in order to obtain the transformation of the solution into a solid material surrounding the part with a shape corresponding to all or part of the object which one wishes to make.

The cross-linking operation may also be carried out at room temperature, when cross-linking may be carried out under cold conditions.

At the end of this cross-linking operation, the part is withdrawn so as to only leave a mold. This withdrawal operation may be preceded with an operation for cutting out the solid material into at least two portions so as to be able to withdraw the part. In this scenario, it is understood that the cut-out portions will be reassembled after withdrawing the part, while if necessary making an inlet intended for subsequent introduction of the curable composition into the mold.

It is also possible to contemplate the making of the mold in several distinct portions (for example, in two portions), to assemble these portions by simple mechanical pressure or by electromagnetism or to disassemble these portions without it being necessary to proceed with a cutting-out operation.

The preparation of the mold is thus finalized, regardless of the embodiment, by introducing one or several removable parts within the mold, for example via an aperture provided for this purpose, the introduction of the removable part(s) may be facilitated by means of a guide, the vacant location required for the presence of the guide may be provided during the molding of the model object, a guide thus being present at this object so that the shape of this guide is printed within the internal cavity of the mold.

As mentioned above, a liquid composition curable by a chemical reaction is introduced into at least one compartment of the internal cavity until the latter is completely filled.

This liquid composition curable by a chemical reaction may be:
a polymerizable and/or cross-linkable organic composition, in which case the final material of the object will be a polymeric organic material; or
a composition consisting in a sol-gel solution, in which case the final material of the object will be a sol-gel material.

This composition may also be prepared prior to step a).

When this composition is a polymerizable and/or cross-linkable composition, this preparation step may consist of putting into contact the ingredients required for making a polymeric organic material in a solvent medium.

More specifically, when the composition is a polymerizable organic composition, the reagents contained in this composition may be:
at least one polymerizable monomer;
optionally, at least one polymerization initiator; and
at least one solvent, for example, an organic solvent, water or a mixture comprising water and an organic solvent.

When the polymerization occurs according to a radical mechanism, a so-called [symbol] chain [symbol] mechanism, mention may be made as monomers, of vinyl monomers, i.e. monomers including at least one carbon-carbon double bond, such monomers may be olefin monomers, styrene monomers, (meth)acrylate monomers (such as methacrylic acid, ethylene glycol dimethacrylate).

As a polymerization initiator, this may in particular be a free radical initiator (notably, when polymerization occurs according to a radical mechanism), such as nitrile compounds like azoisobutyronitrile (symbolized by the acronym AiBN).

When polymerization occurs according to a stepwise polymerization mechanism, the monomers set into play may be pairs of monomers such as:
a pair comprising at least one diamine monomer and at least one dicarboxylic monomer;
a pair comprising at least one monomer bearing at least one —OH group (for example, resorcinol) and at least one monomer bearing at least one aldehyde group (for example formaldehyde).

Finally, when the composition is a cross-linkable composition, the latter may include:
at least one polymer comprising at least one cross-linkable functional group;
a cross-linking agent, when cross-linking is achieved via a chemical route and not via a physical route; and
at least one solvent, for example, an organic solvent, water or a mixture comprising water and an organic solvent.

One skilled in the art, depending on the material making up the object to be made, will suitably select the ingredients required for making said object, whether these are in terms of monomers, of possible polymerization initiators, organic solvents, cross-linkable polymers, optional cross-linking agents.

In addition to the presence of the aforementioned ingredients and of one or several solvents, the composition may comprise other adjuvants such as:
water;
catalysts allowing acceleration of the polymerization and/or cross-linking reaction;
organic or inorganic pigments;
organic compounds with optical properties, such as fluorophores compounds, phosphorescent compounds, anti-UV agents, antireflective agents or compounds having a reactive function with analytes (with view to ensuring the detection of analytes for example).

When the composition is a sol-gel solution, this preparation step may consist of putting into contact one or several metal or metalloid molecular precursors with a medium comprising one or several organic solvents and optionally other adjuvants such as water, a catalyst.

The metal may be selected from a group formed by transition metals, lanthanide metals and so-called post-transition metals of columns IIIA and IVA of the Periodic Classification of the Elements. The transition metal element may be selected from Ti, V, Cr, Mn, Fe, Co, Ni, Cu, Zn, Y, Zr, Nb, Mo, Ru, Rh, Pd, Ag, Cd, Hf, Ta, W, Re, Os, Ir, Pt. The lanthanide element may be selected from La, Ce, Pr, Nd, Sm, Eu, Gd, Tb, Dy, Er, Yb. The post-transition metal element may be selected from the elements of Group IIIA, Al, Ga, In and TI and from the elements of Group IVA, Ge, Sn and Pb.

The metalloid element is advantageously selected from among Si, Se, Te.

These may also be any combinations between transition metals, lanthanide metals, post-transition metals and metalloids.

The molecular metal or metalloid precursors may appear as inorganic salts of a metal or metalloid such as halides (fluorides, chlorides, bromides, iodides), alkaline salts (such as for example sodium silicate).

The metal or metalloid molecular precursors may also appear as organometallic metal or metalloid compounds, such as notably alkoxides for example those fitting the formula (RO)ₙM, wherein M designates the metal or the metalloid, n represents the number of ligands bound to M, this number also corresponding to the degree of oxidation of M and R represents a linear or branched alkyl group which may include from 1 to 10 carbon atoms or a phenyl group.

The metal or metalloid molecular precursors, as described above, are put into contact with a medium comprising an organic solvent, so as to form a sol-gel solution.

Preferably, the solvent is an organic solvent selected from among:
saturated or unsaturated aliphatic or aromatic monoalcohols, for example those of formula R¹—OH, wherein R¹ represents a linear or branched alkyl group, comprising from 1 to 30 carbon atoms, preferably from 1 to 10 carbon atoms or a phenyl group;
diols, for example those of formula HO—R²—OH, wherein R² represents a linear or branched alkylene group comprising from 1 to 30 carbon atoms, preferably from 1 to 10 carbon atoms, or a phenylene group.

As examples of diols, mention may be made of ethylene glycol, diethylene glycol or further triethylene glycol.

In addition to the presence of one or several molecular precursors and of one or several organic solvents, the sol-gel solution may comprise other adjuvants, such as:
water which may contribute to facilitating the gelling process of the sol-gel solution;
catalysts allowing acceleration of the kinetics of the hydrolysis and condensation reactions during the transformation of the sol-gel solution into a gel (these catalysts may be an inorganic acid, such as hydrochloric acid, an organic acid such as acetic acid);
organic or inorganic pigments;
organic compounds with optical properties, such as fluorophore compounds, phosphorescent compounds, anti-UV agents, antireflective agents or compounds having a reactive function with analytes (in order to ensure for example the detection of analytes);
more specifically, compounds able to facilitate detection of compounds, like those described in FR 2 960 799.

Prior to step a), the internal cavity of the mold may be led to being subject to a treatment step (i.e. the surface of the internal cavity intended to be in contact with the curable composition), so as to minimize the adhesion of the cured object and thus facilitate withdrawal of this object from the mold. It is understood that this treatment should not modify, or in any case not in a substantial way, the permeability of the mold towards gases. This surface treatment step may consist of producing hydrophobic silanization of the internal surface of the mold (for example, by means of reagents such as a perfluorinated silane, trichloromethylsilane).

The mold, into which is introduced the composition, may be attached on a mobile, for example rotary, system, which will give the possibility of obtaining objects of better quality, the movement induced by the system, for example a movement of rotation, giving the possibility of preventing a collapse phenomenon of the cured material during the drying process or in other words giving the possibility of acting against the effect of gravity. Advantageously, the mobile system is set into operation exclusively after introduction of the composition and after curing of the composition, concomitantly with the application in the drying step c). This applied movement may also contribute to facilitating the subsequent mold-removal operation notably for microstructured objects in contact with one of the faces of the mold, notably the lower face, the visco-elasticity of the mold giving the possibility of absorbing the impacts during the rotary drying step.

Once step a) is completed, the method comprises a step for curing the introduced composition, the curing concomitantly confining the electrically conducting element.

If the curable composition is a polymerizable and/or cross-linkable composition, the curing step will consist in a polymerization and/or cross-linking step, while, if the curable composition is a sol-gel solution, the curing step will consist in a step for gelling the sol-gel solution.

From a practical point of view, this step may consist of placing the thereby filled mold at rest for a sufficient time and at a sufficient temperature for transforming the sol-gel solution into a gel or of placing it at a suitable temperature for a suitable duration in order to generate polymerization or cross-linking of the composition. This duration and this temperature may be determined by one skilled in the art by routine experiments and may notably vary depending on the volume of the composition, on the proportions and the amounts of ingredients used in this composition. Preferably, the duration of this step is short, in particular less than 20 minutes and, preferably, less than 5 minutes, so as to limit evaporation of the solvent during this step. Indeed, if the aforementioned step is slow (i.e. if the set period is long), this may cause deformation of the polymer and thus a shape of the latter not compliant with the internal cavity of the mold.

Moreover, for applying the polymerization or cross-linking step, the mold may be placed in an environment, which limits evaporation of the solvent through the wall of the mold, such an environment may consist in a closed space saturated with solvent vapor or which may be obtained by lowering the temperature.

After step b), the method of the invention, within the scope of the invention, comprises a step for removal c) of the removable part, when it is unique, or of at least one removable part from the mold, when the mold includes several of them. When the introduction of the removable part(s) has been carried out, during the making of the mold, via one or several guides, the guide(s) maintained within the mold during steps a) and b) give the possibility of facilitating the withdrawal of the removable parts, which guides allow displacement of said part(s) along a single direction, which avoids any random displacements which may degrade the physical integrity of the cured material.

According to an alternative of the invention, the removable part(s) may be in a sacrificial material, i.e. in a material intended to be degraded or to change state and then be removed during the method. In other words, within the scope of this method, when the removable part(s) is(are) in a sacrificial material, the latter may be degraded or may change physical state as a consequence of the operating conditions applied during the curing step, the removal step thus consisting of extracting from the internal cavity (for example, by simple puncture by means of a syringe), the products from the degradation or from the change of state of the sacrificial material, the space left empty having a shape corresponding to that of the removable part(s). As an example of sacrificial materials, mention may be made of waxes, which will be able to change state (more specifically, passing from a solid state to a liquid state) under the applied operating conditions during the curing step, the liquid wax being able to be removed by means of a syringe.

Once the withdrawal step is completed, the method may comprise, in the case when withdrawal would leave an aperture allowing communication of the internal cavity with the outside, a step for closing said mold, preferably with an obturating material able to allow discharge of the gases from step d) just like that of the walls of the internal cavity forming a boundary with the outside.

Once the withdrawal step and the optional step for closing the mold are completed, the method of the invention comprises a drying step (step d), in return for which the gases (including those from the vaporization of the solvent(s)) are removed by evaporation through the walls of the mold.

This drying step may be carried out according to various alternatives, from among which mention may be made of:
drying with a supercritical fluid, such as supercritical carbon dioxide;
drying by heating;
drying in vacuo;
drying under a controlled atmosphere;
a combination of the aforementioned drying methods.

It is not excluded that the drying step may be applied by a combination of the aforementioned alternatives. In particular, when the drying step combines both drying by heating and drying in vacuo, this may give a possibility of substantially reducing the duration of the drying or the drying temperature as compared with drying by heating.

As an example, the drying step may consist of placing the mold in a rotary oven and of heating this mold to a suitable temperature and for a suitable duration (for example, 45° C. for 5 days) in order to allow removal by evaporation of the organic solvent(s), this heating may be combined with application of vacuum.

Once a cycle of steps a), b), c) and d) is completed, the method of the invention may comprise the repetition of one or several of its steps, without necessarily observing the sequence a), b), c) and d). In other words, the method, once a cycle of steps a), b), c) and d) is achieved, may successively comprise a step a) followed by a step b) followed by a step d), without there being any step c) for removing one or several removable parts from the mold.

Additionally, at the end of the method, a step for removing the cured object from the mold is conventionally applied, this withdrawal step may be made by cutting out the mold so as to release the object.

The object formed by the method of the invention may in turn be used as a model for forming a mold, which may subsequently be used in a method comprising steps compliant with the invention (steps a), b), c) and d) as mentioned above), these operations may be repeated as many times as possible until an object having the desired dimensions is obtained. This may be particularly of interest for making microstructured micrometric objects, without having to resort to microstructuration means.

The material making up the object is a polymeric material (such as aerogels, xerogels), when the initial composition is a polymerizable and/or cross-linkable composition, while the material making up the object is a sol-gel material (such as an aerogel or a xerogel) stemming from the drying of the gel, this material may be transformed into a ceramic or into glass with a subsequent heat treatment.

As already mentioned, the method of the invention gives the possibility of contemplating the preparation of objects of the most diverse shapes, this method thus finding application in many fields, such as:
the field of gas detection, the method of the invention may be used for designing sensors allowing electromagnetic waves to be guided, which may appear as particular structures (such as optical fibers);
the field of lasers, the method of the invention may notably be used for designing lasers with coloring agents, the latter may be incorporated into the gel-solution which is at the basis of the preparation of the lasers, the monoliths obtained with the method of the invention having specific dimensions and excellent surface quality;
the field of microfluidics, the method of the invention may notably be used for designing microchannels, which may be elaborated on supports, such as glass plates;
the field of chemical analysis, the method of the invention may notably be used for designing microcolumns intended to enter the structure of chromatographic apparatuses, such as gas chromatography;
the field of electro-osmosis, the method of the invention may notably be used for designing microporous membranes and microchannel devices;
the field of electrophoresis, the method of the invention may notably be used for designing micro reactors;
the field of optics, the method of the invention may be used for designing lenses, wave or light guides and more particularly Fresnel lenses, like microlenses, and arrays of microlenses;
the field of energy, the method of the invention may be used for designing electrode materials, notably for fuel cells or supercapacitors or further for designing materials for storing fuel, such as hydrogen;
the field of microelectronics, the method of the invention may be used for designing insulating materials, piezoelectric materials or dielectric materials, these materials may be microstructured.

As regards optical guides, the latter may be made by means of a porous material obtained by the sol-gel technique, containing a chemical sensor intended to react in the presence of an analyte, such as a gas analyte, the optical properties of the material may change in the presence of a given analyte. In this way it is possible to access great detection sensitivity.

As regards the making of microstructured devices, by means of the method of the invention, it is thus possible to avoid resorting to microstructuration methods, such as etching, the latter may leave an uncontrolled surface condition.

For this:
a microstructured part is used, intended to be reproduced, so as to form a mold;
this part is reproduced by the method of the invention, which gives the possibility of obtaining a part having microstructures with reduced dimensions.

It is possible to repeat these operations, by forming a mold from the part obtained earlier by the method of the invention. By multiplying the repetitions, it is possible to obtain a micrometric part without having to resort to microstructuration means.

In addition to the advantages already mentioned above, the method of the invention is also found to be easy to apply. The invention will now be described with reference to the particular embodiments given below as an illustration and not as a limitation.

### SHORT DESCRIPTION OF THE DRAWINGS

FIG. 1 illustrates the different steps (parts a, b, c, d, e, f, g, h, i, j, k, l and m, respectively) of the preparation of an object compliant with the method of the invention applied in Example 1 below.

FIG. 2 illustrates a three-dimensional view of the manufactured object according to the method of the invention applied in Example 2 below.

FIG. 3 illustrates a three-dimensional view of the model used within the scope of Example 2 below.

FIG. 4 illustrates a transverse sectional view of the model with its dimensions, used within the scope of Example 2 below.

FIG. 5 illustrates the various steps (parts a, b, c, d, e, f, g, h, i and j, respectively) of the preparation of an object compliant with the method of the invention applied in Example 2 below.

FIG. 6 illustrates the various steps (parts a, b, c, d, e, f, g, h, i and j, respectively) of the preparation of an object compliant with the method of the invention applied in Example 3 below.

### DETAILED DISCUSSION OF PARTICULAR EMBODIMENTS

### Example 1

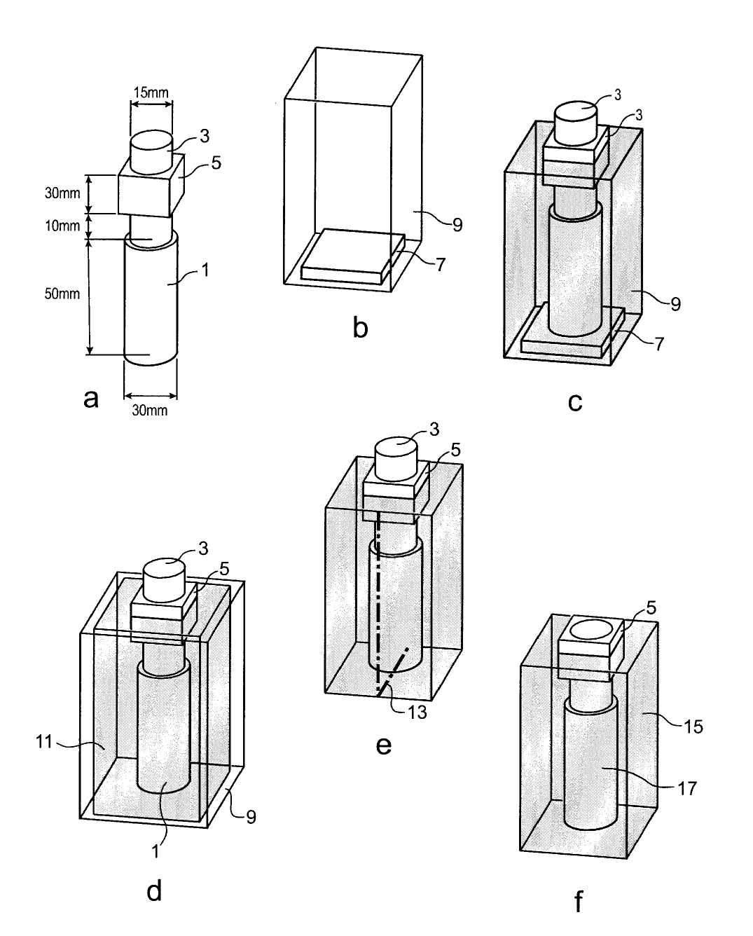

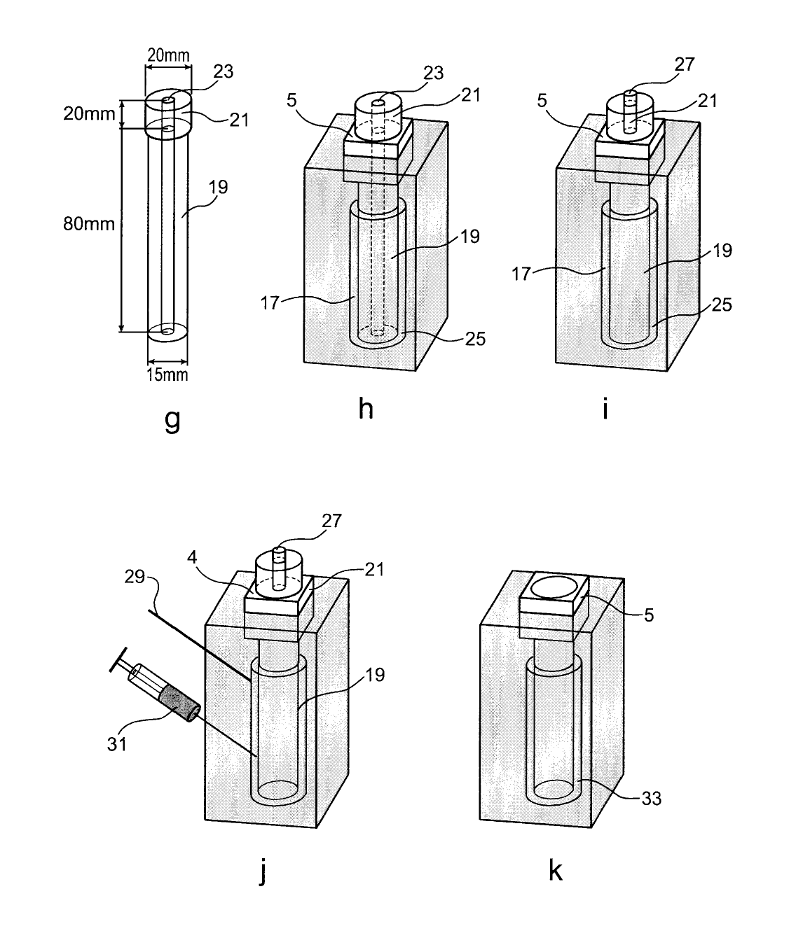

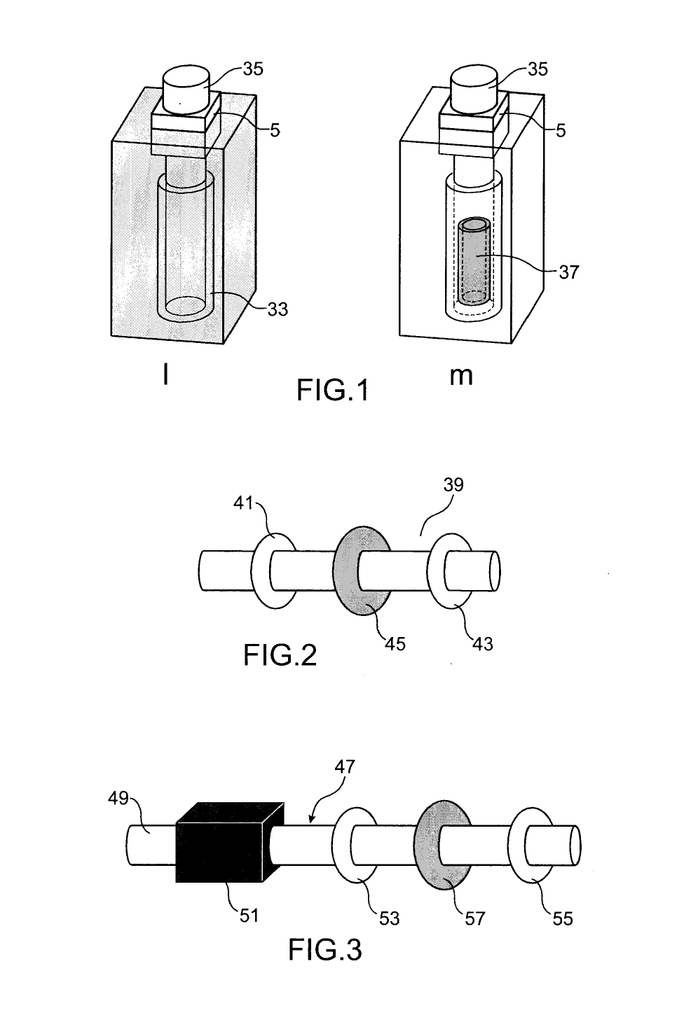

This example illustrates the preparation of an object from the method of the invention, this object appearing as a cylindrical tube closed at one of its ends, which has an external diameter of 15 mm, an internal diameter of 7.5 mm and a height of 25 mm, said object is prepared from an aluminium model of a complex shape illustrated on part a) of FIG. 1, which model comprises two cylindrical portions of respective diameters 30 mm and 15 mm (referenced as 1 and 3 on part a) of FIG. 1) and from a removable guide referenced as 5 with a cubic shape with a side of 30 mm, two opposite faces of which are crossed by a cylindrical hole allowing introduction of the cylindrical portion 3 into this guide.

a) Making the Mold

The mold is prepared by the following succession of operations:

1—Preparation by means of a spatula of a mixture (20 g) of two components, polydimethylsiloxane (PDMS) and a cross-linking agent, respectively according to a ratio of 10/1 (these components being available from Dow-Corning under the name of SylGard 184);

2—Casting 10 g of this mixture 7 into a parallelepipedal container 9 with dimensions (100 mm*40 mm*40 mm) (part b) of FIG. 1);

3—Applying a high vacuum to the assembly for 20 minutes and breaking the vacuum followed by baking at 70° C. for 2 hours;

4—After baking the mixture at 80° C. for one hour (thus generating cross-linking of PDMS), placing the model at the centre of the container, so that the cylindrical portion 1 is in contact with the centre of the PDMS part present at the bottom of the container (part c) of FIG. 1);

5—Preparing by means of a spatula a mixture (140 g) of two components, polydimethylsiloxane (PDMS) and a cross-linking agent, respectively according to a ratio of 10/1 (these components being available from Dow-Corning under the name of SylGard 184) followed by degassing in a high vacuum (20 minutes by breaking the vacuum);

6—Casting the mixture 11 on the model to be molded (laid on the PDMS layer applied beforehand) until immersion of the object down to 80% of the height of the guide (part d) of FIG. 1);

7—Applying a high vacuum for 30 minutes for degassing the assembly;

8—Heating the assembly to 70° C. for 2 hours, so as to generate cross-linking of the polydimethylsiloxane, in return for which a solid layer is formed around the model;

9—Removing from the mold the parallelepipedal container;

10—Opening the PDMS mold into two portions by means of a scalpel along a cutting plane 13 indicated in dotted lines in part e) of FIG. 1 for removing the initial part taken in the PDMS mold;

11—Only placing the removable guide 5 at the upper aperture of the mold (part f) of FIG. 1) and then adhesively bonding both aforementioned portions by a plasma according to the following conditions:

a—Both portions of the mold are placed in an O₂ plasma (Plasma O₂ AST Product Inc.), the following conditions being applied for activating the surface functions of the PDMS (P0₂ 1 bar; Power 20 Watts; Duration 20 s; Adaptation network 50-50%; Gas 120; Gas flow 60; Operating point 0.5);

b—After applying the plasma, both surfaces of the mold to be adhesively bonded are put into contact with each other. Pressure is exerted in order to improve the contact between both surfaces and to thereby improve the adhesion;

c—The assembly is put into the oven at 80° C. for 4 hours, in return for which a mold 15 is obtained, for which the internal cavity 17 has a shape corresponding to that of the model (part f) of FIG. 1);

12—Introducing via the removable guide a rod illustrated on part g) of FIG. 1, this rod comprising a lower cylindrical portion 19 with a diameter of 15 mm and a length of 80 mm and an upper cylindrical portion 21 with a diameter of 20 mm and a length of 20 mm and comprising in its centre a through-hole 23 with a diameter of 1 mm, this hole being intended to allow passing of air during the subsequent removal of the rod (after injection of the sol-gel solution and after gelling), the introduction being achieved through the lower cylindrical portion until the upper cylindrical portion abuts upon the guide, thus leaving the lower end of the lower cylindrical portion at 10 mm from the bottom of the internal cavity 17 of the mold, the thereby made space 25 being intended to form the bottom of the cylindrical tube (part h) of FIG. 1);

13—Obturating the through-hole 23 with a hermetic plug 27 in order to give a [symbol] closed chamber [symbol] nature to the mold on the one hand and for preventing the sol-gel solution from moving up along the hole during the injection of the latter (part i) of FIG. 1) on the other hand.

b) Making the Sol-Gel Solution

The sol-gel solution is prepared by the following succession of operations:

1—Mixing at room temperature with stirring 4.66 mL (0.0208 mol) of tetraethyl orthosilicate (78-10-4 Sigma-Aldrich) and 1.6 mL (0.068 mol) of water, to which are added 4 mL of anhydrous ethanol and then 4 μL of 1 M hydrochloric acid with stirring;

2—Putting the solution obtained in 1 into a hermetically closed pillbox in the oven at 80° C. for 4 hours for hydrolysis;

3—After 4 hours of hydrolysis, withdrawing the solution from the oven and cooling it to room temperature.

c) Making of the Object as Such

The object is prepared according to the following succession of operations:

1—Introducing a needle 29 into the upper portion of the mold so as to allow discharge of the air, when the sol-gel solution will be injected;

2—Adding to the obtained solution according to the preceding paragraph, 0.5 mL of a solution prepared by dissolving 30 μL of an ammonia solution in 5 mL of anhydrous ethanol, the resulting sol-gel solution having to be injected into the mold just after this step.

3—Sampling 5 mL of the sol-gel solution prepared earlier;

4—Inserting the needle 31 of the syringe containing the sol-gel solution (which has just been sampled) into the internal cavity of the mold followed by slow injection of the solution in order to avoid having a turbulent condition at the outlet of the needle 31 and avoid the formation of air bubbles on the walls of the mold (part j) of FIG. 1);

5—Withdrawing the injection needle 31 when the internal cavity of the mold is filled with the sol-gel solution and then withdrawing the needle 29;

6—Putting the mold containing the sol-gel solution to rest at room temperature for 1 hour until a gel is obtained;

7—Withdrawing the hermetic plug 27 and the rod, the guide giving the possibility of maintaining the rod straight during the withdrawal of the rod and of not damaging the gel formed 33 (part k) of FIG. 1);

8—Closing the mold with a hermetic plug 35 with a diameter of 15 mm by obturating the concentric aperture of the guide (part I) of FIG. 1);

9—Drying the assembly in a rotary oven (Agilent technologies, model GA) at 70° C. for 10 days, in return for which an object 37 is obtained in a sol-gel material having reduced dimensions relatively to the model (part m) of FIG. 1);

10—After drying, opening the PDMS mold into two portions in order to withdraw the thereby manufactured object in a sol-gel material.

The obtained object has smaller dimensions than that of the original part (50% shrinkage), without this affecting the shape relatively to the original part.

### Example 2

This example illustrates the preparation of an object from the method of the invention, this object appearing, as illustrated in FIG. 2, as a solid rod 39 provided at each of its ends with a solid ring bound to the rod (41 and 43 respectively) and in its middle portion, with a free solid ring 45, i.e. a solid ring not bound to the rod or further, in other words, which may freely move around the rod.

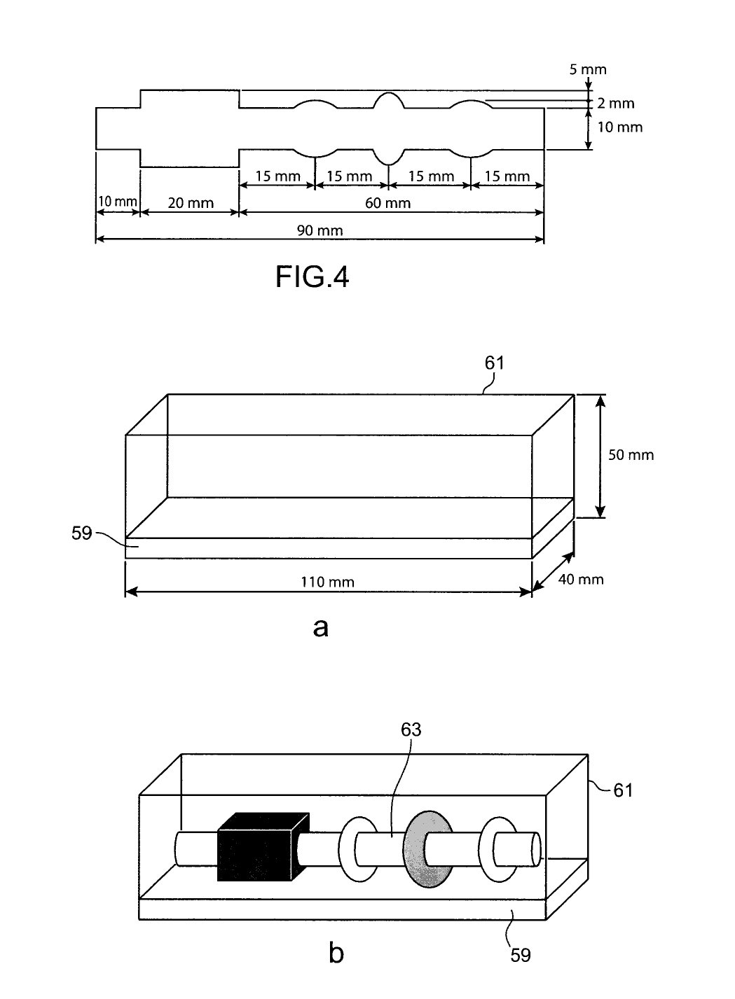

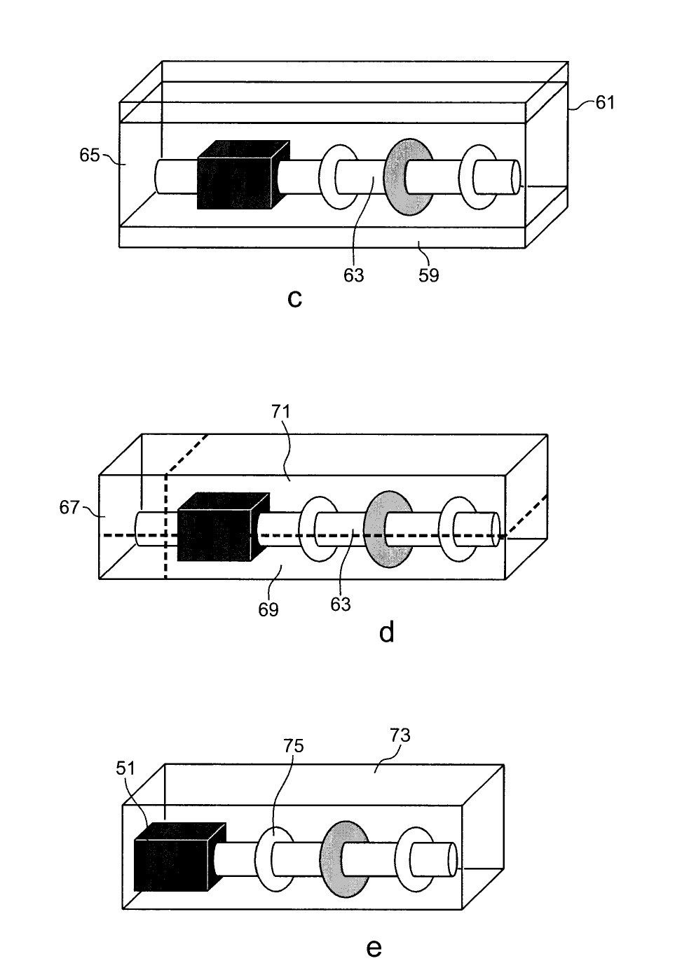

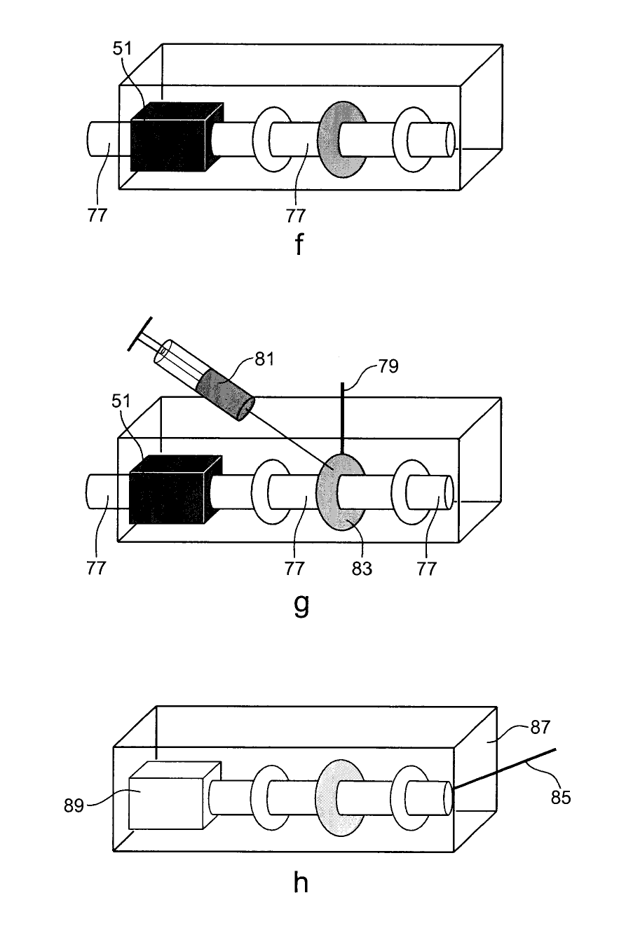

This object is prepared from an aluminium model with a complex shape illustrated in FIGS. 3 and 4 (a three-dimensional view and a sectional view respectively including for the latter the dimensions of the various portions of the model). More specifically, this model consists in a cylindrical rod 47 provided at its upstream end 49 with a guide 51 and then with two rings 53 and 55 surrounding another central ring 57.

a) Making the Mold

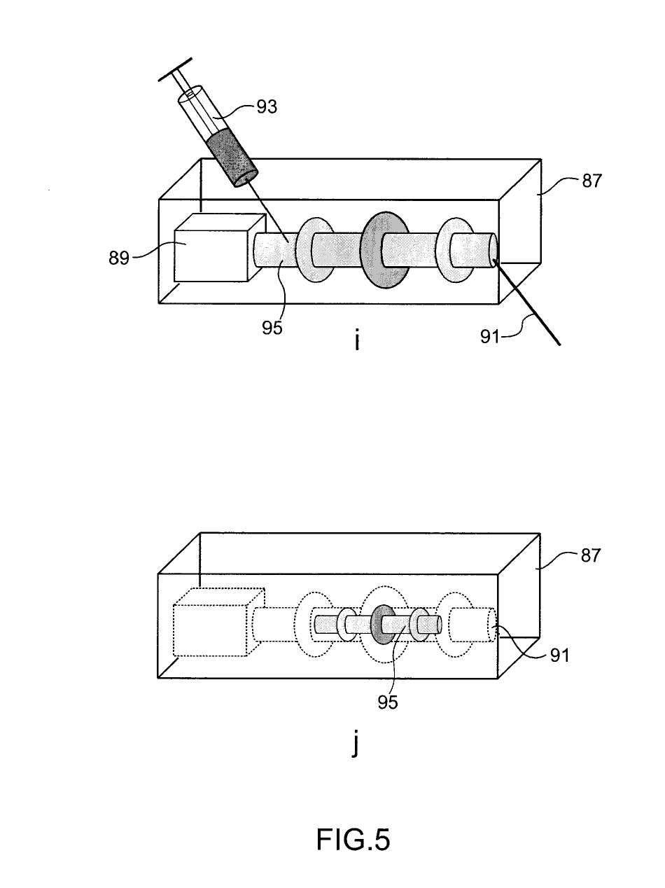

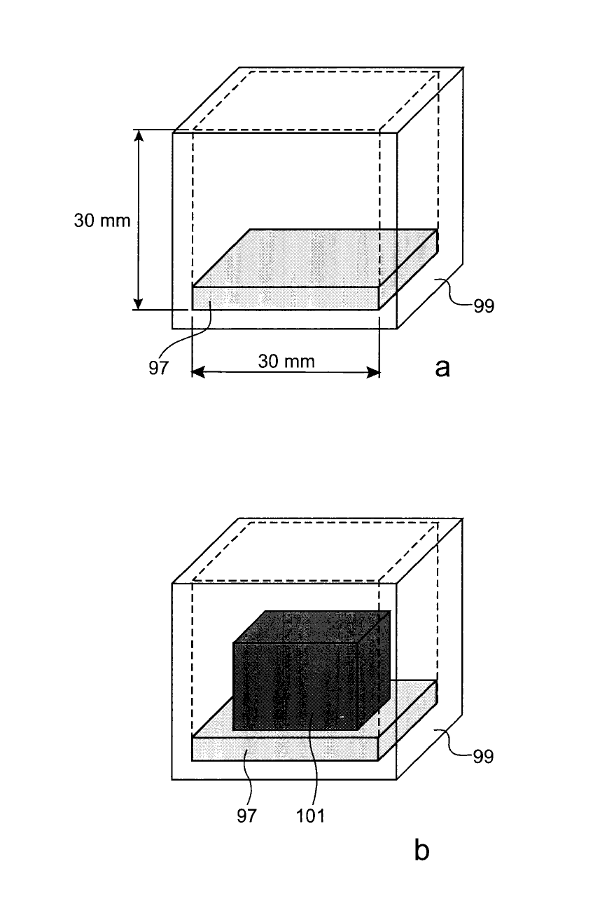

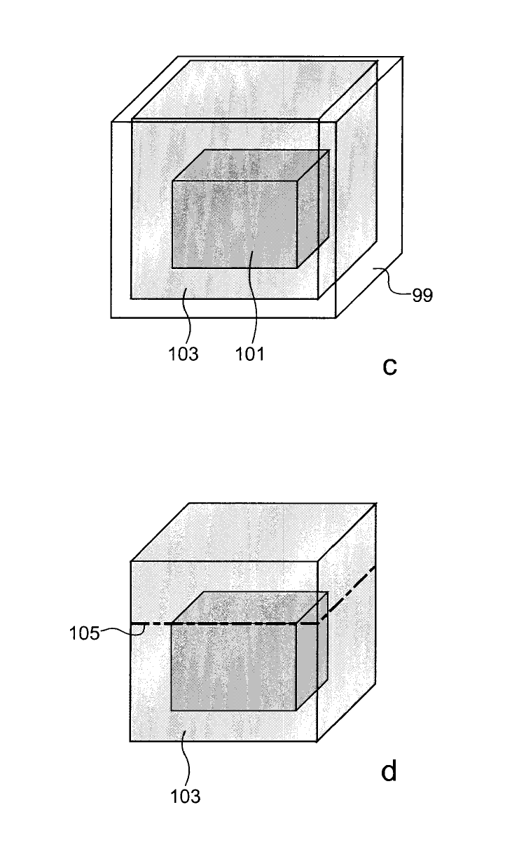

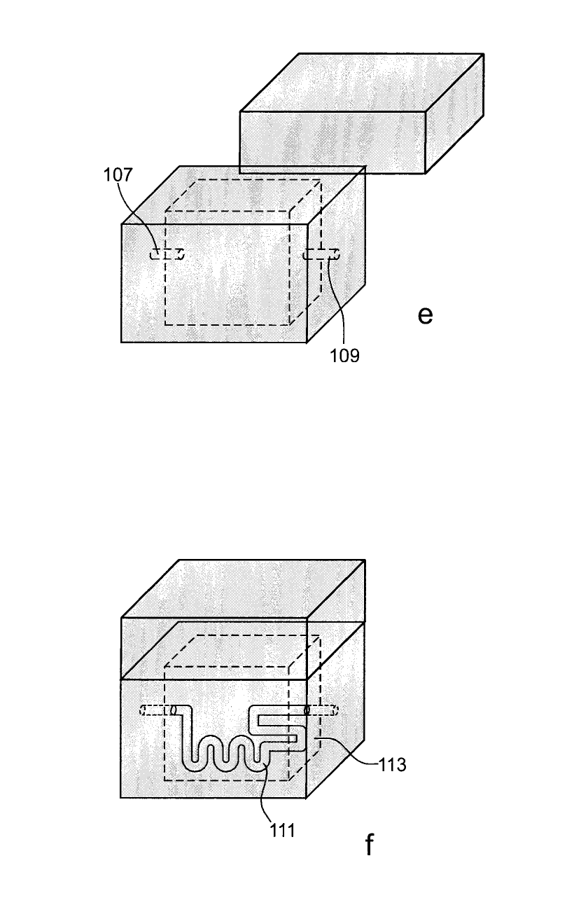

The mold is prepared by the succession of the following operations illustrated by FIG. 5:

1—Preparing by means of a spatula a mixture (35 g) of two components, polydimethylsiloxane (PDMS) and a cross-linking agent, respectively, according to a ratio of 10/1 (these components being available from Dow-Corning under the name of SylGard 184);

2—Casting 25 g of this mixture 59 into a parallelepipedal container 61 in Plexiglas with dimensions (110 mm*40 mm*50 mm) over a height with a thickness of 5 mm (part a) of FIG. 5);

3—Applying high vacuum to the assembly for 20 minutes and breaking the vacuum followed by baking at 70° C. for 2 hours;

4—After baking the mixture (thereby generating cross-linking of the PDMS), placing the model 63 on the obtained PDMS layer (part b) of FIG. 5);

5—Preparing by means of a spatula a mixture (200 g) of two components, polydimethylsiloxane (PDMS) and a cross-linking agent, respectively according to a ratio of 10/1 (these components being available from Dow-Corning under the name of SylGard 184) followed by degassing in a high vacuum (20 minutes by breaking the vacuum);

6—Casting the mixture 65 onto the model to be molded (laid on the PDMS layer applied beforehand) up to a height of 10 mm above the highest portion of the object (part c) of FIG. 5);

7—Applying a high vacuum for 30 minutes for degassing the assembly;

8—Heating the assembly to 70° C. for 2 hours, so as to generate cross-linking of the polydimethylsiloxane, in return for which a solid layer is formed around the model;

9—Removing from the mold the parallelepipedal container;

10—Cutting out the excess of PDMS until a uniform mold thickness of 5 mm is obtained;

11—Opening the PDMS mold into three portions (an end portion 67 being flush with the guide and two portions 69 and 71 crossing over its length the model) by means of a scalpel according to the cutting planes indicated in dotted lines on part d) of FIG. 5 for removing the initial part set in the PDMS mold;

11—Only placing the removable guide 51 at the upper aperture of the mold (part e) of FIG. 5) and then adhesively bonding both aforementioned portions by plasma under the following conditions:

a—Both portions of the mold are placed in an O₂ plasma (Plasma O₂ AST Product Inc.), the following conditions being applied for activating the surface functions of the PDMS (P_{O2}=1 bar; Power 20 Watts; Duration 20 s; Adaptation network 50-50%; Gas 120; Gas flow 60; Operating point 0.5);

b—After applying the plasma, both surfaces of the mold to be adhesively bonded are put into contact. Pressure is exerted for improving the contact between both surfaces and to thereby improve the adhesion;

c—The assembly is put in an oven at 80° C. for 4 hours, in return for which a mold 73 is obtained, having an internal cavity 75 corresponding to the shape of the model, said internal cavity being filled at the space having the shape of the guide of the model by the same guide 51 (part e) of FIG. 5);

12—Introducing via the removable guide left in the mold, a cylindrical solid rod 77 with a length of 100 mm and a diameter of 10 mm also allowing obturation of the concentric hole of the guide and setting up a [symbol] closed chamber [symbol] nature to the mold (part f) of FIG. 5).

b) Making the Sol-Gel Solution

The sol-gel solution is prepared by the following succession of operations:

1—Preparing solution 1: Mixing at room temperature with stirring 4.66 mL (0.0208 mol) of tetraethyl orthosilicate (78-10-4 Sigma-Aldrich) and 1.6 mL (0.068 mol) of water, to which are added 4 mL of anhydrous ethanol and then 4 μL of 1M hydrochloric acid with stirring;

2—Preparing solution 2: Mixing at room temperature with stirring, 9.32 mL (0.0416 mol) of tetraethyl orthosilicate (78-10-4 Sigma-Aldrich) and 3.2 mL (0.068 mol) of water, to which are added 8 mL of anhydrous ethanol and then 8 μL of 1M hydrochloric acid with stirring;

3—Placing solutions 1 and 2 in hermetically closed distinct flasks in the oven at 80° C. for 4 hours for hydrolysis;

4—After 4 hours of hydrolysis, withdrawing the flasks from the oven and cooling the latter to room temperature.

c) Making the Object as Such

The object is prepared according to the succession of following operations:

1—Introducing a needle 79 into the upper portion of the mold so as to allow discharge of the air, when the sol-gel solution will be injected (part g) of FIG. 5);

2—Adding to the solution 1, 0.5 mL of a solution prepared by dissolving 30 μL of an ammonia solution in 5 mL of anhydrous ethanol followed by stirring, the resulting solution having to be used straightaway;

3—Sampling the sol-gel solution prepared earlier by means of a syringe including a needle with a diameter of 0.8 mm;

4—Inserting the needle 81 of the syringe containing the sol-gel solution (which has just been sampled) into a compartment 83 of the internal cavity of the mold corresponding to the central ring followed by slow injection of the solution in order to avoid having turbulent conditions at the outlet of the needle 81 and prevent the formation of air bubbles on the walls of the mold (part g) of FIG. 5);

5—Withdrawing the injection needle 81, when the internal cavity of the mold is filled with the sol-gel solution and then withdrawing the needle for discharging air 79;

6—Putting the mold containing the sol-gel solution to rest at room temperature for 1 hour until a gel is obtained;

7—After introducing a needle 85 for entry of the air at the downstream end 87 of the mold, withdrawing the rod and then the guide, this guide allowing, during the withdrawal of the rod it to be maintained straight so as to avoid damaging the gel (part h) of FIG. 5);

8—Introducing into the vacant space left by the withdrawal of the guide, a PDMS part 89 of same dimensions, so as to restore the “closed chamber” nature to the mold and to allow homogeneous drying of the gel (part h) of FIG. 5);

9—Introducing a needle 91 at the downstream end 87 of the mold for allowing discharge of the air, when the sol-gel solution will be injected (part i) of FIG. 5);

10—Adding to the previous solution 2 a solution prepared by dissolving 30 μL of an ammonia solution in 5 mL of anhydrous ethanol followed by stirring, the resulting solution having to be used straightaway;

11—Sampling the sol-gel solution prepared earlier by means of a syringe including a needle with a diameter of 0.8 mm;

12—Inserting the needle 93 of the syringe containing the sol-gel solution (which has just been sampled) into a compartment 95 of the internal cavity of the mold, the shape of which corresponds to that of the cylindrical rod provided with its two end rings followed by slow injection of the solution in order to avoid having turbulent conditions at the outlet of the needle 93 and avoiding the formation of air bubbles on the walls of the mold (part i) of FIG. 5);

13—Withdrawing the injection needle 93, when the internal cavity of the mold is filled with the sol-gel solution and then withdrawing the air discharge needle 91;

14—Putting the mold containing the sol-gel solution to rest at room temperature for 1 hour until a gel is obtained;

15—Drying the assembly in a rotary oven (Agilent technologies, model GA) at 70° C. for 10 days, in return for which within the mold, the object 95 illustrated in FIG. 2 (part j) of FIG. 5) is obtained;

16—After drying, opening the PDMS mold into two portions for removing the thereby made sol-gel part, the central ring being detached from the rod because of a shrinkage during the drying of the gel stemming from the solution 2, more significant than the obtained with the gel from solution 1.

The obtained object has smaller dimensions than that of the original part (50% shrinkage), without this affecting the shape relatively to the original part.

### Example 3

This example illustrates the preparation of an object from the method of the invention, this object being a cube with a side of 1 cm crossed by a channel with a diameter of 1 mm, in the form of a coil.

a) Making of the Mold

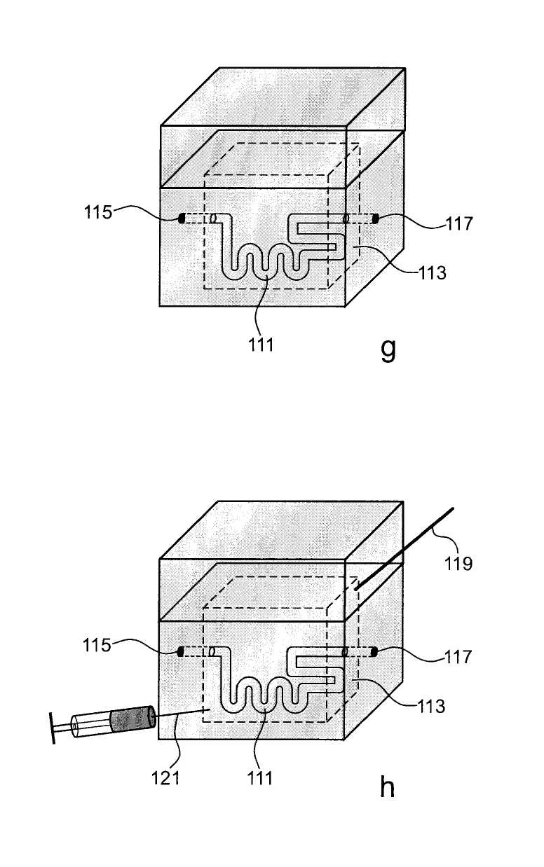

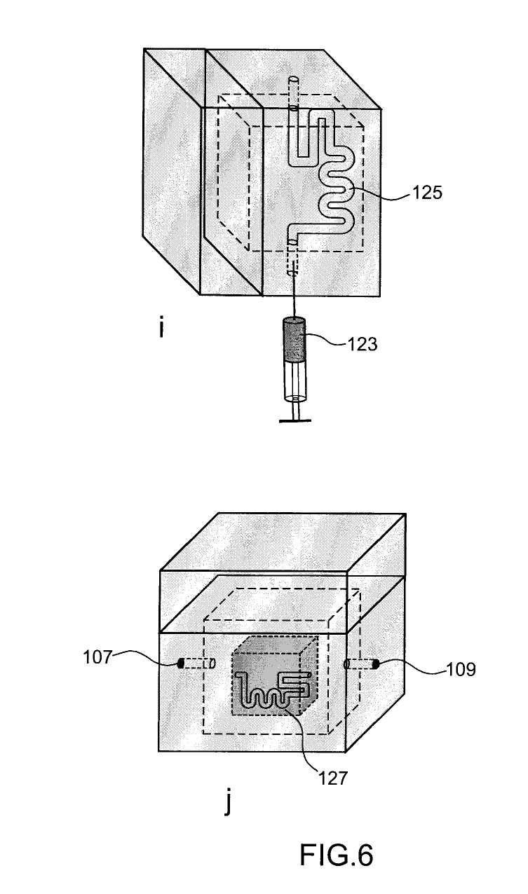

The mold is prepared by a following succession of operations, illustrated by FIG. 6 (parts a) to j)):

1—Preparing by means of a spatula a mixture (10 g) of two components, polydimethylsiloxane (PDMS) and a cross-linking agent, respectively according to a ratio of 10/1 (these components being available from Dow-Corning under the name of SylGard 184);

2—Casting 5 g of this mixture 97 into a Plexiglas container 99 with a cubic shape with a side of 3 cm (part a) of FIG. 6);

3—Applying high vacuum to the assembly for 20 minutes and breaking the vacuum followed by baking at 70° C. for 2 hours;

4—After baking the mixture at 70° C. for two hours (thereby generating cross-linking of the PDMS), placing an aluminium cube 101 with a side of 2 cm on the first PDMS layer (part b) of FIG. 6);

5—Preparing by means of a spatula a mixture (30 g) of two components, polydimethylsiloxane (PDMS) and a cross-linking agent, respectively according to a ratio of 10/1 (these components being available from Dow-Corning under the name of SylGard 184) followed by degassing in a high vacuum (20 minutes by breaking the vacuum);

6—Casting 20 g of the mixture 103 on the object to be molded (laid on the PDMS layer applied beforehand) up to a height of 5 mm above the model (part c) of FIG. 6);

7—Applying a high vacuum for 30 minutes for degassing the assembly;

8—Heating the assembly to 70° C. for 2 hours, so as to generate cross-linking of the polydimethylsiloxane, in return for which a solid layer is formed around the part;

9—Manual removal from the mold of the molding container;

10—Cutting out the mold according to the cutting plane 105 indicated in dotted lines on part d) of FIG. 6, so as to allow release of the cube;

11—After release of the cube, machining two holes 107 and 109 with a diameter of 2 mm on two opposite sides of the mold, these holes having the purpose of attaching a wax coil (part e) of FIG. 6);

12—Placing both portions of the mold in an O₂ plasma (Plasma O₂ AST Product Inc.), the following conditions being applied for activating the surface functions of the PDMS (P_{O2}=1 bar, Power: 20 Watts, Period: 20 seconds, Adaptation network 50-50%; Gas 120; Gas flow 60; Operating point 0.5);

13—After applying the plasma, the wax coil 111 is rapidly set into place by attaching it to both holes and then both surfaces of the mold to be adhesively bonded are put into contact. Pressure is exerted for improving the contact between both surfaces and to thereby improve the adhesion;

14—The assembly is kept at room temperature for two days, in return for which a mold having an internal cavity 113 corresponding to the shape of the object which one wishes to obtain (part f) of FIG. 6) is obtained.

b) Making the Sol-Gel Solution

The sol-gel solution is prepared by the following succession of operations:

1—Mixing at room temperature with stirring 9.32 mL (0.0416 mol) of tetraethyl orthosilicate (78-10-4 Sigma-Aldrich) and 3.2 mL (0.136 mol) of water, to which are added 8 mL of anhydrous ethanol and then 8 μL of 1 M hydrochloric acid with stirring;

2—Putting the solution obtained in 1 in a hermetically closed pillbox in the oven at 80° C. for 4 hours for hydrolysis;

3—After 4 hours of hydrolysis, removing the solution from the oven and cooling it to room temperature.

c) Making the Object as Such

The object is prepared according to the succession of the following operations:

1—Placing hermetic plugs 115 and 117 for plugging the holes formed for supporting the wax coil (part g) of FIG. 6);

2—Introducing a needle 119 into the upper portion of the mold in order to allow discharge of the air, when the sol-gel solution will be injected;

3—Adding to the obtained sol-gel solution above, 1 mL of a solution prepared by dissolving 30 μL of an ammonia solution into 5 mL of anhydrous ethanol, the resulting sol-gel solution having to be injected into the mold just after this step;

4—Inserting the needle 121 of the syringe containing 10 mL of the sol-gel solution (which has just been sampled) into the internal cavity of the mold followed by slow injection of the solution in order to avoid having turbulent conditions at the outlet of the needle 119 and avoiding the formation of air bubbles on the walls of the mold (part h) of FIG. 6);

5—Putting the mold containing the sol-gel solution to rest at room temperature for 1 hour until a gel is obtained;

6—Heating the assembly to 50° C., up to the melting of the wax coil.

Suction of the molten wax with a syringe 123 and then washing the thereby obtained channel 125 with a solvent (preferably ethanol, a solvent which was used for formulating the sol-gel) (part i) of FIG. 6);

7—Withdrawing the syringe 123 and obturating the inlet orifice of the hole 107 and then drying the assembly in a rotary oven (Agilent technologies, model GA) at 70° C. for 10 days at a speed of rotation of less than one revolution per minute, the dried object 127 having a shrinked portion with respect to the original object (part j) of FIG. 6);

8—After drying, opening the PDMS mold into two portions for removing the thereby made object.

The obtained object has smaller dimensions than those of the original part, without this affecting the shape with respect to the original part.

1. A method for manufacturing a molded object from a mold comprising an internal cavity comprising one or several compartments and at least one removable part present within said internal cavity, said object being in a cured organic or inorganic material, said method successively comprising at least one cycle of:
a) completely filling at least one compartment of the internal cavity of the mold, said compartment having a shape corresponding to all or part of the object, which one wishes to obtain, with a curable liquid composition by chemical reaction for forming said material, said composition comprising at least one solvent;
b) curing by chemical reaction said composition within said mold;
c) withdrawing at least one removable part from said mold; and
d) drying within said mold the cured composition obtained in b), wherein all or part of a) to d) may be repeated with a curable liquid composition either identical or different from the one used during said cycle until the molded object is obtained and,
wherein said mold, at least during the application of each d) is a closed chamber, the walls of which forming a boundary between the internal cavity and the outside of the mold are in at least one material able to allow discharge of the gases from said step d).

2. The method according to claim 1, wherein the walls forming a boundary between the internal cavity and the outside of the mold are in an elastomeric material.

3. The method according to claim 1, wherein the walls forming a boundary between the internal cavity and the outside of the mold comprises at least one polysiloxane.

4. The method according to claim 1, wherein the walls forming a boundary between the internal cavity and the outside of the mold comprise at least one polydimethylsiloxane.

5. The method according to claim 1, comprising, before a), preparing the mold for the object to be made.

6. The method according to claim 1, comprising, before a), preparing the curable liquid composition.

7. The method according to claim 1, wherein the withdrawal is carried out with at least one guide, which will allow displacement of the removable part(s) along a single direction, in order to avoid all random displacements which may degrade the physical integrity of the cured material.

8. The method according to claim 1, wherein the method comprises, in the case when the withdrawal leaves an aperture allowing communication of the internal cavity with the outside, closing said mold.

9. The method according to claim 1, wherein the removable part(s) is(are) in a sacrificial material that is a material intended to be degraded or to change state and then be removed during the method.

10. The method according to claim 1, wherein the curable liquid composition comprises
a polymerizable and/or cross-linkable organic composition and the cured organic material of the object is a polymeric organic material.

11. The method according to claim 1, wherein the curable liquid composition comprises a sol-gel solution and the cured inorganic material of the object is a sol-gel material.

12. The method of claim 8 that comprises closing said mold with an obturating material able to allow release of the gases from d).
